(19) United States
(12) Patent Application Publication
(10) Pub. No.: US 2025/0322484 A1
(43) Pub. Date: Oct. 16, 2025

(54) DISPLAY PROCESSOR

(71) Applicant: Arm Limited, Cambridge (GB)

(72) Inventors: Damian Piotr Modrzyk, Katowice (PL); Brian Paul Starkey, Cambridge (GB); Phil Young, Cambridge (GB); Robert Sarkoezi, Biatorbagy (HU)

(73) Assignee: Arm Limited, Cambridge (GB)

(21) Appl. No.: 19/173,100

(22) Filed: Apr. 8, 2025

(30) Foreign Application Priority Data
Apr. 12, 2024 (GB) 2405272.2
Jul. 5, 2024 (GB) 2409826.1

(51) Int. Cl. G06T 1/20

(52) U.S. Cl. CPC G06T 1/20

(57) ABSTRACT

A display processing unit for a data processing system comprises an input unit operable to read and process one or more input surfaces, a processing unit operable to process one or more input surfaces to generate an output surface, and an output unit operable to provide an output surface for display to a display. The input unit comprises a first data path for the reading and processing of uncompressed input surfaces for providing to the processing unit, and a second, different data path for the reading and processing of compressed surfaces for providing to the processing unit.

### BACKGROUND

The technology described herein relates to display processors (display processing units) for data processing systems.

In data processing systems, an image that is to be displayed to a user is typically processed by a so-called “display processor” (display processing unit) of the data processing system for display.

Typically, the display processor will read an image or images to be displayed from a so-called “frame buffer” in memory which stores the image(s) as a data array (e.g. by internal direct memory access (DMA)) and provide the image data appropriately to the display (e.g. via a pixel pipeline) (which display may, e.g., be a screen or printer). The image or images to be displayed are stored in the frame buffer in memory, e.g. by a graphics processor, when they are ready for display, and the display processor will then read the frame buffer and provide the output image to the display for display.

The display processor (display processing unit) processes the image(s) from the frame buffer(s) to allow it to be displayed on the display. This processing includes appropriate display timing functionality (e.g. it is configured to send pixel data to the display with appropriate horizontal and vertical blanking periods), to allow the image(s) to be displayed on the display correctly.

The Applicants believe that there remains scope for improvements to display processors for data processing systems.

### BRIEF DESCRIPTION OF THE DRAWINGS

Various embodiments of the technology described herein will now be described by way of example only and with reference to the accompanying drawings, in which:

FIG. 1 shows a data processing system;

FIG. 2 shows schematically a display processor an embodiment of the technology described herein;

FIG. 3 shows schematically an input unit of a display processor an embodiment of the technology described herein;

FIG. 4 shows schematically an encoding unit of a display processor an embodiment of the technology described herein;

FIG. 5 shows schematically encoder/decoder operation in an embodiment;

FIGS. 6A and 6B show schematically a compressed data read transaction in an embodiment;

FIGS. 7A and 7B show schematically a compressed data write transaction in an embodiment; and

FIG. 8 shows schematically an encoder/decoder unit in an embodiment.

Like reference numerals are used for like components throughout the drawings, where appropriate.

### DETAILED DESCRIPTION

A first embodiment of the technology described herein comprises a display processing unit for a data processing system, the display processing unit comprising:

at least one set of processing units comprising: an input unit operable to read and process one or more input surfaces, a processing unit operable to process one or more input surfaces to generate an output surface, and an output unit operable to provide an output surface for display to a display;
wherein:
the input unit comprises:
a first data path for the reading and processing of an input surface that is to be read from memory in an uncompressed form for providing to the processing unit; and
a second, different data path for the reading and processing of an input surface that is to be read from memory in a compressed form for providing to the processing unit.

According to second embodiment of the technology described herein comprises a method of operating a display processing unit for a data processing system, the display processing unit comprising:
at least one set of processing units comprising: an input unit operable to read and process one or more input surfaces, a processing unit operable to process one or more input surfaces to generate an output surface, and an output unit operable to provide an output surface for display to a display;
wherein:
the input unit comprises:
a first data path for the reading and processing of an input surface that is to be read from memory in an uncompressed form for providing to the processing unit; and
a second, different data path for the reading and processing of an input surface that is to be read from memory in a compressed form for providing to the processing unit;
the method comprising:
when an input surface is to be read from memory in an uncompressed form for providing to the processing unit, reading and processing the input surface via the first data path of the input unit; and
when an input surface is to be read from memory in a compressed form for providing to the processing unit, reading and processing the input surface via the second data path of the input unit.

The technology described herein relates to a display processing unit (a display processor) that comprises at least one (a) set of processing units. The set of processing units of the display processor includes an input unit (such as, and in an embodiment, a layer processing unit) configured to read and process one or more input surfaces (layers) and an output unit configured to provide an output surface (frame) for display to a display.

The set of processing units further comprises a processing unit (such as, and in an embodiment, a composition unit) configured to process an input surface or surfaces to provide an output surface.

The input unit comprises a first data path for the reading and processing of an input surface that is to be read from memory in an uncompressed form for providing to the processing unit, and a second, different data path for the reading and processing of an input surface that is to be read from memory in a compressed form for providing to the processing unit.

As will be discussed further below, this configuration and functionality of display processing unit can provide an efficient and effective configuration for the handling within the display processing unit of input surfaces (layers) that are stored in memory in uncompressed or compressed form.

The display processor may include a single set of processing units, but in an embodiment includes plural, e.g., two, (corresponding) sets of processing units.

Each set of processing units is in an embodiment configured in a corresponding manner (and thus in an embodiment comprises, for example, a respective input unit, processing unit and output unit).

Each input unit of a set of processing units may comprise any suitable such unit configured to read and process at least one input surface. In an embodiment, the input unit comprises a layer processing unit.

In an embodiment, the input unit comprises a memory access sub-system comprising, e.g., and in an embodiment, a memory access controller, such as for example a Direct Memory Access (DMA) controller.

The memory access sub-system in an embodiment also comprises a translation lookaside buffer (TLB), and in an embodiment a TLB pre-fetcher, and any other suitable memory access units (circuits), and, in an embodiment, an appropriate interface with a memory management unit accessible to and for use by the display processing unit.

The memory access sub-system in an embodiment supports read accesses to memory, but in an embodiment supports both read and write accesses to memory.

The input unit is operable to (configured to) read at least one input surface from a memory in which the at least one input surface is stored. The memory may comprise any suitable memory and may be configured in any suitable and desired manner. For example, it may be a memory that is on-chip with the display processor or it may be an external memory. In an embodiment it is an external memory, such as a main memory of the overall data processing system. It may be dedicated memory for this purpose or it may be part of a memory that is used for other data as well. In an embodiment at least one or each input surface is stored in (and read from) a frame buffer.

An input surface read by a set of display processing units (input unit) may be any suitable and desired such surface. In one embodiment, at least one or each input surface is an image, e.g. frame, e.g., and in an embodiment, for display.

The input surface or surfaces can be generated as desired. For example one or more input surfaces may be generated by being appropriately rendered and stored into a memory (e.g. frame buffer) by a graphics processor (a graphics processing unit (GPU)). Additionally or alternatively, one or more input surfaces may be generated by being appropriately decoded and stored into a memory (e.g. frame buffer) by a video codec. For example, a common use case would be for the display processor to fetch an input surface that is decoded by and output from a video codec (video decoder) and then buffered in a frame buffer. Additionally or alternatively, one or more input surfaces may be generated by a digital camera image signal processor (ISP), or other image processor. The input surface or surfaces may be, e.g., for a game, a graphical user interface (GUI), a GUI with video data (e.g. a video frame with graphics “play back” and “pause” icons), etc.

There may only be one input surface that is read by a set of processing units (and processed to generate an output surface), but in an embodiment there are plural (two or more) input surfaces that are read by a set of processing units (and processed to generate an output surface).

The input unit in an embodiment further comprises one or more and in an embodiment plural layer processing pipelines configured to perform one or more processing operations on one or more input surfaces, as appropriate, e.g. before providing the one or more processed input surfaces to the corresponding processing unit (composition unit), or otherwise. One or more of the layer pipelines may comprise a video layer pipeline and/or one or more of the layer pipelines may comprise a graphics layer pipeline. Each of the one or more layer pipelines may be operable, for example, to provide pixel processing functions such as pixel unpacking, colour conversion, (inverse) gamma correction, and the like.

In an embodiment an input unit further comprises one or more latency hiding buffers, e.g. in the form of one or more FIFO (first-in-first-out) stages, e.g. for buffering the input surfaces read by the input unit, or otherwise, as appropriate.

In an embodiment, each layer processing pipeline of the input unit has an associated latency hiding buffer. Thus, where, for example, there are four layer processing pipelines, there will be four latency hiding buffers, one for each layer pipeline. Thus, in an embodiment, an input surface to be processed will be read from memory and provided to (stored in) a latency hiding buffer before being provided from the latency hiding buffer to a corresponding layer processing pipeline for processing.

As discussed above, in the technology described herein, an input unit of a set of processing units of the display processing unit includes a first data path for the reading and processing of an input surface that is stored in memory in an uncompressed form, and a second, different data path for the reading and processing of an input surface that is stored in memory in a compressed form.

The first data path (for uncompressed data) in an embodiment comprises the (uncompressed) data that is read from memory being passed to the layer processing pipeline that is to process the input surface in question, in an embodiment via the latency hiding buffer for that input processing pipeline, in an embodiment from the memory read (DMA) unit of the memory access sub-system.

In an embodiment, this data path also comprises a reorder unit (reorder buffer) that is configured and operable to re-order data of a surface read from memory into the appropriate (e.g. linear/raster) order for providing to the corresponding layer processing pipeline.

Thus, in an embodiment, for uncompressed (input) surface data, the data path for that surface data once read by the memory access sub-system (so, in an embodiment, from the memory read (DMA) unit of the memory access sub-system) is through a reorder unit (buffer) to a latency hiding buffer and then to a layer processing pipeline.

Thus, in an embodiment, the first data path (for uncompressed data) comprises (and in an embodiment only comprises) (after the memory read (DMA) unit of the memory access sub-system (and correspondingly after the TLB unit of the memory access sub-system)), a reorder unit (buffer), followed by a latency hiding buffer, followed by a layer processing pipeline.

In the case of the second, different data path for input surfaces that are stored in a compressed form in memory, that data path in an embodiment includes an appropriate decoding unit (decoder) (that is part of the input (layer processing) unit) that is operable to decode the compressed data received from memory before it is provided to the appropriate layer processing pipeline. In an embodiment, the decoding unit is provided intermediate the TLB unit and the DMA unit of (and in an embodiment as part of) the memory access sub-system of the input unit.

(It will be appreciated in this regard therefore that the decoding unit (decoder) is (in an embodiment) “tightly” integrated and associated with the input unit and in an embodiment with the memory access sub-system of the input unit.)

(The first data path (for uncompressed data) correspondingly and in an embodiment bypasses and/or “passes through” without undergoing any processing, the decoding unit (decoder) of the second, different data path. In an embodiment, the first data path simply bypasses the decoding unit of the second data path (e.g. by the data being passed directly from the TLB unit to the DMA unit of the memory access sub-system of the input unit for the first data path, without passing through the decoding unit). In other arrangements, there could be a “bypass” (“passthrough”) data path through the decoding unit (decoder) that is used for the first data path, such that uncompressed data in that case passes through the decoding unit (decoder) of the second, different data path without any processing by the decoding unit (decoder).)

The data decoder that is operable to decompress input surface data for processing can be any suitable and desired data decoder.

The data decoder should, and in an embodiment does, comprise an appropriate decoding circuit(s) operable to and configured to decode (decompress) (compressed) input surface data.

The data decoder is in an embodiment configured to use a block-based decoding (compression) scheme, and thus correspondingly, is configured to decode compressed data representing blocks of uncompressed data (“compression units” of uncompressed data) using a block-based encoding (compression) technique.

The data decoder can be configured to use any suitable and desired block-based encoding (compression) technique. The compression scheme may encode data in a lossless or lossy manner, and using variable or fixed-rate compression. The data encoder may support and be configured to be able to perform a plurality of different forms of block-based encoding, which may, e.g., and in an embodiment, be set in use (e.g. on an output-by-output basis).

In an embodiment the data decoder comprises (local) storage, e.g. a buffer, configured to store the data that is to be decoded, e.g. while the data is being decoded and/or before the data is sent onwards for processing, as appropriate. Thus, the data may be temporarily buffered in the data decoder while it is being decoded, before it is output, etc.

In an embodiment, the data decoding unit (decoder) is operated and configured substantially as described in United States Patent Application Publication No. US 2024/0086340 A1 (Arm Limited), the entire content of which is incorporated herein by reference. Thus, in embodiments, data decoding unit (decoder) corresponds to a codec as described in that reference.

In an embodiment, the second, different, data path for compressed input surfaces further comprises (after the decoding stage) a de-swizzle and/or rotation unit (circuit) that is operable and configured to de-swizzle, and/or rotate decompressed blocks of data for the input surface to reorder the data elements in those blocks of data into a different order (where, for example, the compressed data is stored in memory in a swizzled or interleaved order) and/or the blocks of data require rotation before processing to place the data in a more appropriate order for processing by a layer processing pipeline for display.

In an embodiment, the second, different data path, also comprises a de-tiling unit (stage) operable to and configured to convert blocks of decompressed data for an input surface into an appropriate linear (raster) order for provision to a layer processing pipeline (as in the case where the compressed surface data represents blocks of surface data elements, those blocks of data elements will need reordering into an appropriate linear (data element) order (“raster lines”) for processing by the layer processing pipelines for display).

The de-tiling unit in an embodiment provides a linear (raster) output of data elements for the input surface to the appropriate latency hiding buffer for the surface to then be processed by the layer processing pipeline.

Thus, in an embodiment, the second, different data path includes a decoding unit, in an embodiment followed by de-swizzle and/or rotation unit, in an embodiment followed by a de-tiling unit, in an embodiment then followed by the appropriate latency hiding buffer and layer processing pipeline. The decoding unit is in an embodiment arranged intermediate the TLB unit and the DMA unit of the memory access sub-system of the input unit (with the de-swizzle and/or rotation unit then being (logically) after the DMA unit in the data path).

The second, different data path for compressed input surfaces may also include a reorder unit, but the second, different data path need not, and in an embodiment does not, include a reorder unit (in contrast to the first data path for use for uncompressed input surfaces).

In order to support the operation of requesting of reading and processing compressed input surfaces in this manner, the input unit (layer processing unit) in an embodiment also comprises an appropriate read request generating unit (circuit) ((read) requestor unit (circuit)) that is operable to and configured to generate appropriate read requests for requesting data of (compressed) input surfaces from memory that will then be handled via the second, different data path for those surfaces.

Such read requests should provide all of the appropriate data required to access the appropriate data for the (compressed) input surface in question, and are in an embodiment sent to and via the DMA unit of the input unit. The DMA unit of the input unit in an embodiment correspondingly is appropriately configured to be able to handle such read requests for data from memory. Corresponding, the TLB unit of the input unit is in an embodiment correspondingly configured to be able to perform appropriate address translations for read requests for such compressed input surfaces.

The operation of the decoding unit (decoder) in the technology described herein is in an embodiment controlled using bus transactions, for example similarly to as described in United States Patent Application Publication No. US 2024/0086340 A1 (Arm Limited), the entire content of which is incorporated herein by reference.

Thus, in an embodiment, the read request is in the form of a bus transaction on a communications bus over which bus transactions to access memory can be performed (a bus transaction that comprises the data decoder accessing memory). Correspondingly, the read request unit is in an embodiment operable to and configured to issue bus transactions over an (internal) bus of the display processor (to the data decoder).

The read request unit (circuit) may thus be, and in an embodiment is, operable to act as a bus “master” (which may also be referred to as a bus “requester” or “initiator”).

The read request unit in an embodiment comprises a bus interface (bus adapter) that is in communication with a communications bus, and via which the requestor unit can initiate bus transactions on the bus. The requestor unit in an embodiment is operable to initiate bus transactions by issuing bus transaction requests on a communications bus, and in an embodiment to control bus transactions initiated by the requests.

Correspondingly, the data decoder is in an embodiment operable to and configured to receive bus transactions (over an (internal) bus of the display processor), and to, in response to such a bus transaction over a (the) communications bus, access memory.

In an embodiment, the data decoder comprises a bus transaction initiating circuit (e.g. a bus interface) configured to initiate over the communications bus, bus transactions to access memory. In an embodiment, the data decoder is operable to access the memory by the bus transaction initiating circuit of the data decoder initiating over the communications bus, a bus transaction to access the memory. Thus, in an embodiment, the arrangement is effectively such that in response to receiving a (first) bus transaction initiated by the requestor unit, the data decoder initiates a (second) bus transaction to access the memory.

In other words, the data decoder can in an embodiment be triggered to access memory by (receiving) an appropriate bus transaction request. The data decoder unit may thus be, and in an embodiment is, operable to act as a bus “slave” (which may also be referred to as a bus “completer” or “follower”). Moreover, the data decoder in an embodiment is operable to access memory via a communications bus (during a bus transaction).

A bus transaction request that initiates a “data decoder” bus transaction may include an indication that the request relates to compressed data, and the data decoder may respond appropriately on that basis.

In an embodiment, the requestor unit can issue a specific, in an embodiment selected, in an embodiment predetermined, signal that indicates that an associated bus transaction relates to compressed data (and so should comprise the data decoder accessing the memory). Correspondingly, the data decoder in an embodiment responds appropriately (accesses the memory) in response to receiving such a “compressed data” signal.

In an embodiment, the data decoder determines whether the data decoder should access memory in response to a received bus transaction request, in an embodiment based on whether or not the request indicates (e.g. by including an appropriate signal) that the data decoder should do so (e.g. whether or not the request is indicated as being related to compressed data). When it is determined that the data decoder should access memory in response to a received bus transaction request, the data decoder in an embodiment accesses the memory as appropriate.

When, however, it is not determined (it is other than determined) that the data decoder should access memory, the data decoder in an embodiment does not access the memory. Thus, there may be some bus transaction requests that should effectively bypass the data decoder. The data decoder may not respond (at all) to a bus transaction request that does not indicate that the data decoder should respond (that is not indicated as being related to compressed data). However, in an embodiment, the data decoder is operable to forward (over a communications bus) any bus transaction requests that do not indicate that the data decoder should respond (e.g. that are not indicated as being related to compressed data), e.g. and in an embodiment, such that the forwarded requests can reach and trigger other components of the system via the communications bus appropriately.

Thus in an embodiment, the data decoder includes a bypass circuit that is operable to forward (over a communications bus) received bus transaction requests that do not indicate that the data decoder should respond (e.g. that are not indicated as being related to compressed data). In other embodiments, however, the system may be configured such that only bus transaction requests that a data decoder should respond to are received by the data decoder, e.g. such that requests that are not intended for the data decoder bypass the data decoder.

In an embodiment, the input unit also supports the writing out of correspondingly compressed surfaces to memory, such as a processed (e.g. composited) output surface that as well as, or instead of, being displayed, is also to be stored in memory, e.g. for further processing (e.g. to act as an input surface for another output surface).

Thus, in an embodiment, the input unit also comprises a write out data path via which a surface may be written out to memory in a compressed form. The write out path should and in an embodiment does include an encoding (compressing) unit (circuit) (a data encoder) for compressing the data in the required format before it is written out to memory.

In an embodiment, this write out data path includes an appropriate write out layer processing pipeline operable and configured to process a surface to be written out to memory, followed by a latency hiding buffer, in an embodiment in the form of one or more FIFO stages, for buffering the surface to be written out to memory before it is compressed (as the surface to be written out from memory will typically be provided in a linear, raster (data element) order, but will be compressed using a block-based compression scheme (as discussed above), such that the received surface data to be written out will need to be buffered so that it can be reconfigured into appropriate blocks for compressing).

Correspondingly, the write out path in an embodiment comprises an appropriate tiling and/or swizzling unit (stage) for organising the linear output surface data into an appropriate tiled (block based) configuration for compressing.

These stages are in an embodiment configured in the write out path before the DMA controller that performs the write control, with the DMA controller then being followed by an encoder (compression) unit which is then followed by the TLB unit that operates to write the (now compressed) surface data to memory.

Thus, in an embodiment, the write out data path comprises a write out layer processing pipeline followed by a latency hiding buffer, followed by a tiling and/or swizzling unit (stage), followed by a data encoding unit (encoder). The data encoding unit (encoder) is in an embodiment positioned in the write out path between the DMA controller that performs the write control and the TLB unit of the memory access sub-system of the input unit.

Where the input unit supports a write out data path, then there could be a separate data encoding unit and data decoding unit for the respective read and write paths, but in an embodiment there is a combined (shared) encoding/decoding unit (codec) that is arranged and triggered appropriately in and for the (appropriate) read and write data paths.

In order to support the operation of requesting of reading and processing compressed input surfaces in this manner, the input unit (layer processing unit) in an embodiment also comprises an appropriate write request generating unit (circuit) ((write) requestor unit (circuit)) that is operable to and configured to generate appropriate write requests for this operation.

Such write requests should provide all of the appropriate data required to store the appropriate data for the (compressed) output surface in question, and are in an embodiment sent to and via the DMA unit of the input unit. The DMA unit of the input unit in an embodiment correspondingly is appropriately configured to be able to handle such write requests. Correspondingly, the TLB unit of the input unit is in an embodiment correspondingly configured to be able to perform appropriate address translations for write requests for such compressed output surfaces.

In an embodiment the write requests are configured and handled as bus transactions (as discussed above for read requests (and thus in an embodiment as described in United States Patent Application Publication No. US 2024/0086340 A1 (Arm Limited))).

In an embodiment, the input unit further comprises a third, different data path that is configured for the reading and processing of compressed surfaces that are compressed in a different (compressed) form to the compressed surfaces that are handled via the second data path. In an embodiment, this third data path is configured for the handling of output surfaces that have been compressed using ARM Frame Buffer Compression (AFBC) (as described in US-A1-2013/0034309), for example.

In this case, this third data path in an embodiment should and in an embodiment does comprise an appropriate (e.g. AFBC) decoder for decoding the compressed input surfaces that are to be handled via this third data path. In an embodiment, it also comprises a reorder unit (reorder buffer) prior to the decoder unit (stage). This may be a separate reorder unit to the reorder unit that is used for the first, uncompressed data path, but in an embodiment, the first and third data paths share the same reorder buffer.

The third data path in an embodiment also comprises a de-tiling unit (buffer) (following the decoding stage). Again, the third data path may have its own, separate, de-tiling unit, but in an embodiment, there is a single de-tiling unit that is shared between (by) the second and third data paths.

Thus, in an embodiment, the third data path comprises (after the memory read sub-system operation), a reorder unit (buffer) which is shared with the first data path, followed by a decoder unit (stage), followed by a de-tiling unit (stage) which is shared with the second data path, followed by the appropriate latency hiding buffer and layer processing pipeline to be used for the input surface in question.

The input unit (and the display processing unit) may be controlled to handle an input surface (and to write an output surface) via the appropriate data path in any suitable and desired manner. In an embodiment, this is controlled by the driver for the display processor, e.g. and in an embodiment, by the driver setting appropriate indication of the type of input surface to be processed so that the input unit can be configured appropriately to process the input surface in question. It will be appreciated that for any given output surface to be generated, there may be plural input surfaces, with those input surfaces having different compression “status”, and so being handled by different data and processing paths within a given input unit.

The input unit of a set of processing units should be, and is in an embodiment, configured to provide the input surface(s) that it reads and processes to an associated processing unit for processing to generate an output surface.

Each output surface generated by a (processing unit of a) set of processing units may be any suitable and desired such surface. In an embodiment each output surface that is generated by a set of processing units is at least one output window, and in an embodiment an image, e.g. frame, for display. An output surface that is generated by a set of processing units (the processing unit of the set of processing units) may be a “final” output surface for display (on a display), or an “intermediate” output surface to be passed to another set of processing units (for further processing). As will be discussed further below, in embodiments, each output surface is composited from plural input surfaces (although this need not be the case).

In an embodiment, the processing unit comprises a composition stage (subsystem) configured to compose (two or more) surfaces to generate a composited surface. Each composition stage may be configured to compose surfaces to generate a composited surface in any suitable manner as desired. In an embodiment, at least one or each composition stage is configured to blend the surfaces to generate a composited surface.

The input surfaces and the composited/output surface(s) may have the same or different sizes, resolutions, etc.

In an embodiment, the processing unit also or instead, and in an embodiment also, comprises a rotation stage (unit/circuit) configured to rotate one or more surfaces, in an embodiment one or more of the input surfaces, e.g. to generate one or more rotated input surfaces. This is particularly useful where, for example, it is necessary and/or desired to rotate one or more of the input surfaces (windows), e.g. prior to compositing or otherwise. (This rotation stage may be additional or alternative to the rotation performed by the de-swizzle and/or rotation unit (circuit) mentioned above.)

In an embodiment, the processing unit also or instead, and in an embodiment also, comprises one or more scaling stages or engines (units/circuits) configured to scale (e.g. upscale and/or downscale) one or more surfaces, e.g. to generate one or more scaled surfaces. Each scaling stage (circuit) may be configured to scale any one, some, or all of the (in an embodiment modified) input surfaces, a composited surface, and/or an (the) output surface.

In an embodiment, at least one or each of the one or more scaling stages (circuits) are configured to scale one or more of the input surfaces, e.g. so as to generate one or more scaled input surfaces. This is particularly useful where, for example, it is desired to scale one or more of the input surfaces, e.g. prior to composition, prior to passing to another set of display processing units, or otherwise.

Additionally or alternatively, at least one or each of the one or more scaling stages (circuits) may be configured to scale an output surface, e.g. to generate a scaled composited output surface. This is particularly useful where, for example, it is desired to scale an output surface, e.g. prior to displaying it, or otherwise.

As will be appreciated from the above, the processing unit of a set of processing units in an embodiment comprises a plurality of processing stages or elements (units/circuits), and in an embodiment comprises one or more of, and in an embodiment all of: a composition stage (engine (unit)), a scaling stage (engine (unit)), and a rotation stage (engine (unit)). Correspondingly, the processing of the at least one input surface to generate an output surface in an embodiment comprises one or more of and in an embodiment all of: rotation, composition, and scaling.

The output unit of a set of processing units of the display processor of the technology described herein may be any suitable such output unit configured to provide an output surface for display to a display, e.g. to cause an output surface for display to be displayed on the display (to act as a display interface). Each output unit in an embodiment comprises appropriate timing control functionality for the display (e.g. it is configured to send pixel data to a display with appropriate horizontal and vertical blanking periods).

In an embodiment, at least one, and in an embodiment each, output unit also comprises one or more “post-processing” stages (circuits), e.g. in the form of a post-processing pipeline, configured to selectively perform one or more processing operations on an output surface, e.g. to generate a post-processed output surface. At least one or each of the one or more post-processing stages (circuits) may comprise, for example, a colour conversion stage (circuit) configured to carry out colour conversion on a surface, a dithering stage (circuit) configured to carry out dithering on a surface, and/or a gamma correction stage (circuit) configured to carry out gamma correction on a surface.

Each output unit should, and is in an embodiment configured to, receive an output surface for display (before providing it to the display) directly from within the internal set(s) of processing units of the display processor.

In an embodiment, a, and in an embodiment each, output unit can, and is configured to be able to, receive an output surface for display, in an embodiment directly, from the processing unit of the set of display processing units that the output unit belongs to.

In an embodiment, as well as one or more sets of processing units configured in the manner discussed above, the display processor (the display processor unit) also includes a different (separate) encoding unit (circuit) that is operable to compress (encode) surfaces stored in memory and store those compressed surfaces in the memory. In an embodiment, this additional compression unit supports the same compression schemes that the input units (layer processing units) of the set or sets of processing units support.

Thus, in an embodiment, this additional compression unit includes at least a first data path that is operable to encode (and then write to memory) input surfaces using the same encoding scheme(s) and processing as is used for the second data path in the set or sets of processing units.

Thus in an embodiment, this first data path includes an encoding (compressing) unit (circuit) for compressing the data in the required format before it is written out to memory.

Correspondingly, the data path in an embodiment comprises an appropriate tiling and/or swizzling and/or rotation unit (stage) (prior to the encoding stage) for organising the surface data to be compressed into an appropriate tiled (block based) configuration for compressing.

Thus, in an embodiment, the first data path comprises, following a memory read subsystem (a DMA unit of a memory read subsystem), a tiling and/or swizzling and/or rotation unit (state), followed by a data encoding unit (stage), followed by a write out stage for writing the encoded (compressed) data back to memory).

The encoding unit in an embodiment also comprises an appropriate write request generating unit (circuit) that is operable to and configured to generate appropriate write requests for such write (encoding) operations. Such write request (and encoding) operation is in an embodiment performed as discussed above (as bus transactions, etc.).

In an embodiment, this separate encoding unit also includes a second, different data path, that supports encoding (compression) using a different encoding scheme (and in an embodiment the encoding scheme that is used for the third data path in the set or sets of processing units).

In this case, this data path in an embodiment comprises an appropriate (e.g. AFBC) encoder for encoding the surfaces that are to be handled via this (encoding) data path. In an embodiment, it also comprises a reorder unit (reorder buffer) prior to the encoder unit (stage). This data path in an embodiment also comprises a tiling unit (buffer).

Thus, in an embodiment, this second, different data path comprises a reorder unit (reorder buffer) followed by a tiling unit (buffer), followed by the encoding unit (encoder), followed by a write out stage (unit) for writing the compressed data back to memory.

In an embodiment, the reorder unit (reorder buffer) is integrated with (performed as part of) the memory read (DMA) unit of the memory access sub-system (with data read for the first data path not undergoing any reordering as part of the memory read (DMA) operation).

Correspondingly, in an embodiment, the tiling unit (buffer) is associated with and operated as part of the encoding unit (encoder) of this data path (and accordingly is a separate tiling unit (stage) to the tiling unit (stage) of the first data path).

The display processor in an embodiment comprises a control unit, that, e.g., and in an embodiment, has an appropriate interface for receiving control signals from the, e.g. driver (e.g. a programming interface). In an embodiment the control unit can also signal interrupts to the host processor (e.g. to the driver on the host processor) so as to facilitate control of the display processor.

The control unit may be provided as an overall (centralised) control unit of the display processor, or may be provided as one or more separate, e.g. distributed, units that together provide the overall control of the display processor.

The control unit can in an embodiment selectively activate sets of processing units.

The control unit can in an embodiment configure appropriate control registers of the sets of processing units. In this case, each respective unit of a set of processing units, thus the input unit, processing unit and output unit (if present), etc., in an embodiment has its own respective set of control registers that can be configured accordingly by the control unit to control the operation of that unit of the set of processing units. Other arrangements would, of course, be possible.

The control unit operates in response to signals received by the control unit. Such signals are in an embodiment provided from a host processor of the data processing system that the display processor is part of, e.g., and in an embodiment, in response to requests for the display of images by an application or applications executing on the host processor.

In an embodiment, a driver for the display processor is provided (and executes) on the host processor, which driver then generates the appropriate control commands (instructions) that are received by the control unit for controlling the operation of the display processor. The driver in an embodiment generates the control commands in response to instructions received for display processing from an application or applications executing on the host processor.

The various units, stages, etc., of the display processor of the technology described herein may be implemented as desired, e.g. in the form of one or more fixed-function units (hardware) (processing circuits) (i.e. that is dedicated to one or more functions that cannot be changed), or as one or more programmable processing units (stages), e.g. by means of programmable processing circuits that can be programmed to perform the desired operation. There may be both fixed function and programmable units or stages (processing circuits).

In some embodiments, the display processor comprises, and/or is in communication with, one or more memories and/or memory devices that store the data described herein, and/or that store software for performing the processes described herein. The display processor is in an embodiment also in communication with a host microprocessor, and/or with one or more (and in an embodiment plural, in an embodiment two) displays for displaying output surfaces generated by the display processor.

Each display that the display processor of the technology described herein is used with may be any suitable and desired display, such as for example, a screen or a printer. In an embodiment, one display comprises the overall data processing system's (device's) local display (screen), and another (a second) display comprises an external display (e.g. connected via a wired or wireless connection).

In an embodiment, the display processor of the technology described herein forms part of a data processing system. Thus, another embodiment of the technology described herein comprises a data processing system comprising the display processor described above.

The data processing system may and in an embodiment does also comprise one or more of, and in an embodiment all of: a central processing unit, a graphics processing unit, a video processor (codec), a system bus, a memory controller, a main memory, and a display or displays (e.g. a local display).

The display processor and/or data processing system may be, and in an embodiment is, configured to communicate with one or more of (and the technology described herein also extends to an arrangement comprising one or more of): an external memory (e.g. via the memory controller), one or more local displays, and/or one or more external displays.

The display processor of the technology described herein may be operated in any appropriate and desired manner.

In an embodiment the display processor is operable in plural modes of operation, i.e. the display processor is in an embodiment controllable to operate in plural modes of operation as appropriate and/or desired.

As discussed above, in an embodiment, the mode of operation of the display processor is controlled by an application, e.g. running on a host processor, in an embodiment by the application generating instructions which are interpreted by a driver for the display processor (that is running on the host processor) to generate appropriate commands to the display processor to operate as required by the application.

In operation, the display processor may be (and in an embodiment is) used to provide output surfaces to one or plural displays, e.g. to a first (local) display and/or a second (external) display. Where output surfaces are provided to plural (two) displays, the output surfaces for display may be the same or different, for example one display may require and use a different resolution and/or embodiment ratio to the other display.

The technology described herein can be implemented in any suitable system, such as a suitably configured micro-processor based system. In an embodiment, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, unless otherwise indicated, the various functional elements, units, stages, and “means” of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits) and/or programmable hardware elements (processing circuits) that can be programmed to operate in the desired manner.

It should also be noted here that, as will be appreciated by those skilled in the art, the various functions, etc., of the technology described herein may be duplicated and/or carried out in parallel on a given processor. Equally, the various processing units, stages, etc., may share processing circuits, etc., if desired.

Furthermore, any one or more or all of the processing units, stages, etc., of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing units, stages, and processing unit (stage) circuits of the technology described herein may be provided as a separate circuit element to any one or more of the other processing units, stages or processing stage circuits, and/or any one or more or all of the processing units, stages and processing stage circuits may be at least partially formed of shared processing circuits.

Subject to any hardware necessary to carry out the specific functions discussed above, the display processor can otherwise include any one or more or all of the usual functional units, etc., that display processors include.

It will also be appreciated by those skilled in the art that all of the described embodiments of the technology described herein can, and in an embodiment do, include, as appropriate, any one or more or all of the features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a display processor, or data processing system comprising a data processor causes in conjunction with said data processor said controller, or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CD-ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

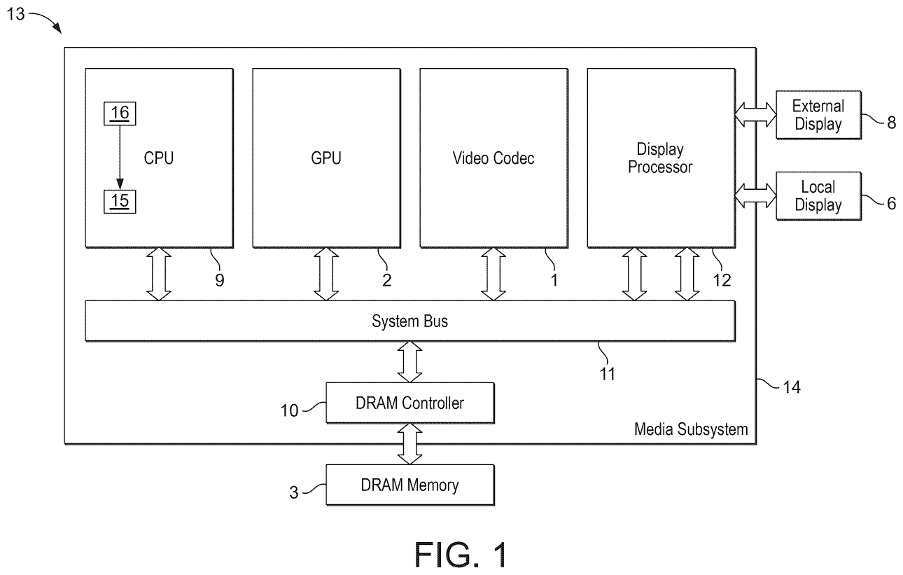

FIG. 1 shows a data processing system 13 that includes a display processor 12. The data processing system 13 includes a media processing subsystem 14, in the form of a system on-chip (SoC).

As shown in FIG. 1, the media processing subsystem 14 comprises a central processing unit (CPU) 9, graphics processing unit (GPU) 2, a video codec 1, a display processor 12, and a memory (DRAM) controller 10. As shown in FIG. 1, these communicate via an interconnect 11 and have access to off-chip main memory 3.

The display processor 12 also has interfaces to a local display 6 of the data processing system (which may, e.g., be a display panel of the device, e.g. mobile phone, that the data processing system is part of), and an interface (e.g. an HDMI, MHL, or Display Port, MIPI DSI, etc., interface) to a second, external display 8 (which may, for example, be an HD TV).

The CPU 9 executes, inter alia, a driver 15 for providing control signals and data to the display processor 12 to control and configure the display processor 12 to process input surfaces to generate appropriate output surfaces for display (and otherwise), in response to commands and data received from applications 16 executing on the CPU 12 that require the display of frames (images) on a display or displays.

In operation of this system, one or more input surfaces will be generated by the video codec 1, GPU 2 and/or CPU 9, and stored in the main memory 3. The stored input surfaces will then be read by the display processor 12 and, e.g. combined (composed) to generate a (e.g. composited) output surface or surfaces for display, which output surface(s) are then provided to one or both of the local display 6 and external display 8 by the display processor 12 for display.

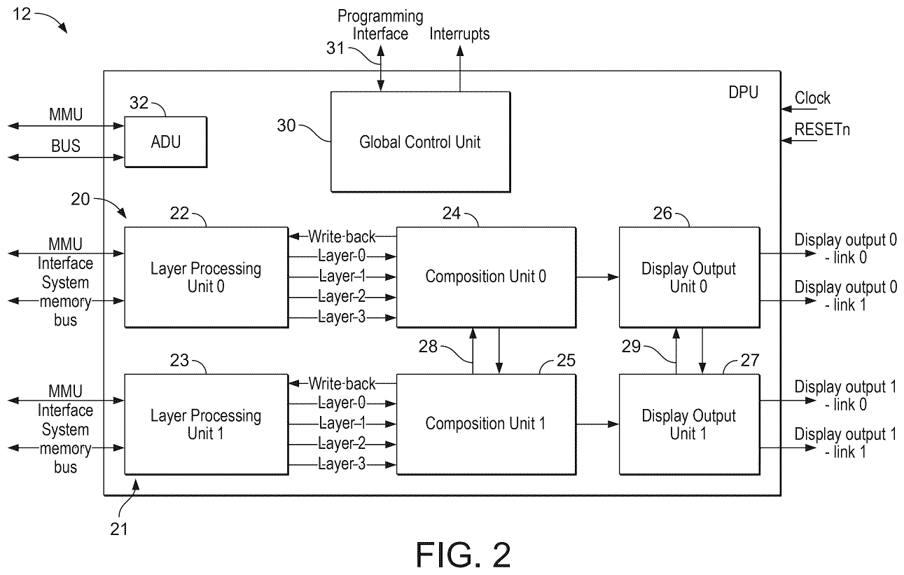

FIG. 2 shows the display processor (display processing unit (DPU)) 12 in an embodiment in more detail.

As shown in FIG. 2, the display processor 12 includes a first set of processing units 20 and a second set of processing units 21.

Each set of processing units is, as shown in FIG. 2, operable to read-in one or more input surfaces, process those input surfaces to generate an output surface or surfaces, and to then provide an output surface to a respective display.

In order to do this, each set of processing units includes a respective input unit 22, 23 in the form of a layer processing unit that, as will be discussed in more detail below, is operable to read one or more surfaces from memory (as shown in FIG. 2), process those surfaces and then provide those surfaces to a respective processing (composition) unit 24, 25. The processing (composition) units 24, 25 are each operable to process input surfaces received, for example, from their respective input units, and to perform processing such as scaling and composition of those input surfaces, to generate an output surface.

Each set of processing units further includes a respective output unit 26, 27, in the form of a display output unit, which is operable to receive, as shown in FIG. 2, an output surface from the respective processing (composition) unit of their set of processing units, and to provide that output surface to a display for display (via an appropriate display interface).

In the present embodiment, the first set of processing units 20 is configured to provide its display output to the local display 6 of the data processing system, and the second set of processing units 21 is configured to provide its display output to an external display interface (to the external display 8). Other arrangements would, of course, be possible.

As shown in FIG. 2, the display processor 12 also includes internal data paths 28, 29 via which (RGB) pixel data for a surface may be passed between respective units of the respective first and second sets of processing units. In particular, as shown in FIG. 2, there is an internal data path 28 via which surface data may be passed between the composition units 24, 25 of the two sets of processing units, and a further internal data path 29 via which pixel data for a surface may be passed between the output units 26, 27 of the first and second sets of processing units.

As shown in FIG. 2, the display processor 12 (the display processor unit) also includes a different (separate) encoding unit (circuit) (ADU) 32 that is operable to compress (encode) surfaces stored in memory and store those compressed surfaces in the memory. This additional compression unit supports the same compression schemes that the input units (layer processing units) of the set or sets of processing units support.

As shown in FIG. 2, the display processor 12 also includes a control unit 30. This control unit 30 is operable to control and configure the operation of the sets of processing units, the encoding unit 32, etc. of the display processor 12, in response to control signals 31 received from the driver 15 for the display processor 12. The control unit 30 provides software access (from the host CPU 9) to the appropriate control registers, interrupt infrastructure, etc. of the display processor 12.

In particular, an application will generate instructions which are interpreted by the driver 15 for the display processor 12 (that is running on the host processor) to generate appropriate commands to the display processor 12 to operate as required by the application. The driver programs appropriate control registers in the control unit 30, and the control unit furthers translates this configuration into hardware control signals for the units of the display processor. Thus, different modes of operation such as dual display composition can be enabled or disabled dynamically by software, depending on the requirements of the high-level application.

The first and second sets of processing units 20, 21, the encoding unit, and the global control unit 30 are all provided as part of the same processing core, and thus, for example, as shown in FIG. 2, share a common clock and reset inputs.

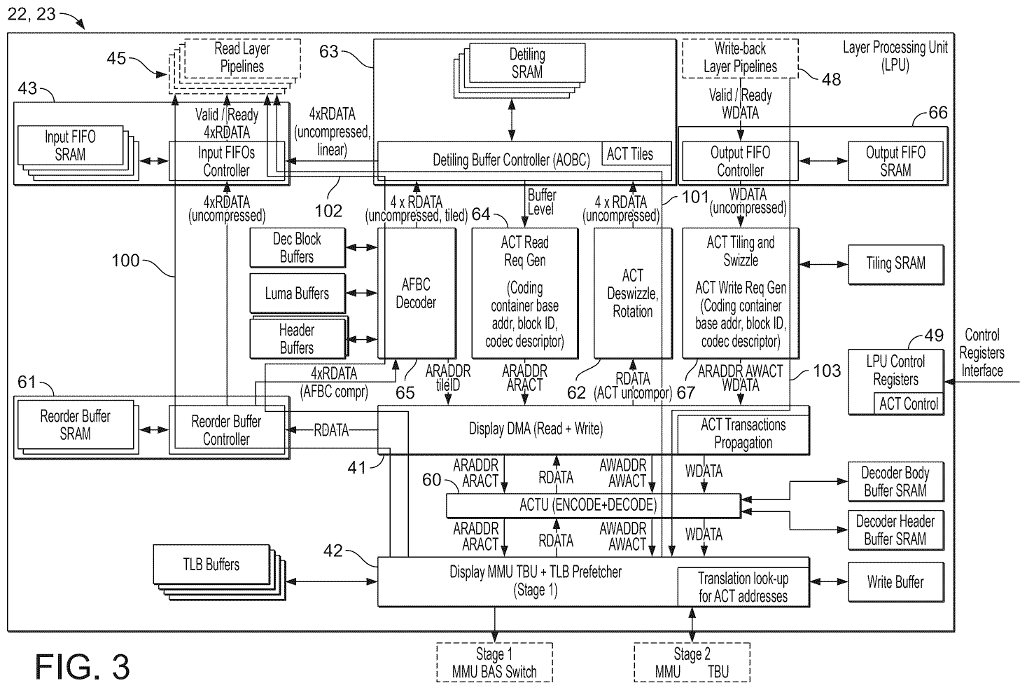

FIG. 3 shows an input unit (layer processing unit) of a set of data processing units of the display processor 12 in an embodiment in more detail. In the present embodiments, each input unit 22, 23 has the configuration shown in FIG. 3.

As shown in FIG. 3, each input (layer processing) unit includes a memory subsystem that includes a direct memory access (DMA) read and write controller 41 and appropriate translation lookaside buffer 42 functionality to allow it to read one or more input surfaces, e.g. from one or more frame buffers, in the main memory 3 via the memory bus (and as shown in FIG. 2 and FIG. 3 to also be able to write one or more surfaces from the display processor 12 to (one or more frame buffers in) the main memory 3).

As shown in FIG. 3, each input (layer processing) unit also includes a latency buffers subsystem 43 that includes one or more real-time FIFO (first in, first out) modules which are used to buffer the one or more input surfaces as they are read from memory and/or decoded, e.g. for latency hiding purposes.

The input surfaces read by the input (layer processing) unit are, as shown in FIG. 3, provided (via the latency buffer subsystem 43) to respective layer pipelines of a layer pipeline subsystem 45. In the present embodiment, the layer pipeline subsystem 45 includes four (input) layer pipelines and so the input unit can read and process up to four different input surfaces (layers) for use to generate an output surface (frame). The input layers may comprise, for example, one or more video layers, e.g. generated by a video processor (codec) 1, one or more graphics layers, e.g. graphics windows generated by a graphics processing unit (GPU) 2, and so on.

(However it will be appreciated that any number of layer pipelines may be provided and used in the technology described herein, depending upon the application in question (and also depending upon any silicon area constraints, etc.).)

Each layer pipeline performs appropriate operations on the input surfaces, such as pixel unpacking from the received data words, colour (YUV to RGB) conversion, and inverse transform (gamma) correction such as sRGB.

The layer pipelines output respective RGB pixel data of the input surface that they have processed to the processing (composition) unit of their respective set of display processing units (as shown in FIG. 2).

As shown in FIG. 3, the input units also include a writeback layer pipeline 48 (and an overall writeback path) to allow surfaces from the processing (composition) unit to be written back to the main memory, if desired. This may be appropriate where, for example, a surface to be displayed will also be required for future use.

As shown in FIG. 3, the input (layer processing) unit also includes an appropriate set of control registers 49 having an appropriate interface to the control unit 30 via which the operation of the input (layer processing) unit can be set and controlled in use by the control unit 30.

As shown in FIG. 3, the input (layer processing) unit also includes an integrated codec (encode/decode) unit (circuit) (ACTU) 60 (logically) intermediate the DMA controller 41 and the TLB 42. The operation of this ACT encode/decode unit 60 will be discussed in more detail below, but it is essentially operable to decode compressed surface data from the memory 3 and to encode (compress) surface data for writing to the memory 3 in response to read and write requests to that effect from a read requestor 64 and a write requestor 67, respectively.

The read requestor 64 is operable to and configured to generate appropriate read requests in the form of bus transactions for requesting data of (compressed) input surfaces from memory that should be decoded by the ACT encode/decode unit 60.

Such read requests provide all of the appropriate data required to access the appropriate data for the (compressed) input surface in question, and are sent to and via the DMA unit 41 of the input unit. The DMA unit of the input unit correspondingly is appropriately configured to be able to handle such read requests for data from memory. Corresponding, the TLB unit 42 of the input unit is configured to be able to perform appropriate address translations for read requests for such compressed input surfaces.

The write requestor 67 is operable to and configured to generate appropriate write requests in the form of bus transactions for this operation.

Such write requests provide all of the appropriate data required to store the appropriate data for the (compressed) output surface in question, and are sent to and via the DMA unit 41 of the input unit. The DMA unit of the input unit correspondingly is appropriately configured to be able to handle such write requests. The TLB unit 42 of the input unit is correspondingly configured to be able to perform appropriate address translations for write requests for such compressed output surfaces.

As shown in FIG. 3, the input (layer processing) unit 22, 23 is configured to have three data paths for the reading and processing of input surfaces.

The first data path 100 is for input surface data that is stored in uncompressed form in memory. In this case, the surface data read from memory bypasses (or passes through without any processing) the ACT encode/decode unit 60, to a reorder unit 61 (where it may be re-ordered for subsequent processing) to the latency buffer subsystem 43 and thence to the appropriate layer processing pipeline.

There is then a second data path 101 for input surface data that is stored in memory in a block-based compressed form that will be decompressed by the ACT encode/decode unit 60 (so triggered by a read request from the read requestor 64).

In this case, the surface data read from memory is first passed to the ACT encode/decode unit for decoding. The decoded data is then passed to a deswizzle/rotation unit 62 for any necessary deswizzling/rotation and then to a detiling unit 63 that reorganises the surface data into an appropriate raster line (linear) order for subsequent processing. The “detiled” surface data is then passed to the latency buffer subsystem 43 and thence to the appropriate layer processing pipeline.

There is then a third data path 102 for input surface data that is stored in memory in a different compressed form (that is not decodable by/to be decoded by the ACT encode/decode unit 60). In the present embodiment, this third data path is configured for the handling of output surfaces that have been compressed using ARM Frame Buffer Compression (AFBC) (as described in US-A1-2013/0034309, for example (the entire content of which is incorporated herein by reference).

In this case, the surface data read from memory bypasses (or passes through without any processing) the ACT encode/decode unit 60 to a reorder unit 61 (where it may be re-ordered for subsequent processing) (which is shared with the first data path 100) and then to an appropriate decoder unit 65 to be decoded. The decoded (now uncompressed surface data) is then passed to the detiling unit 63 (which is shared with the second data path) to reorganise the surface data into an appropriate raster line (linear) order for subsequent processing. The “detiled” surface data is then passed to the latency buffer subsystem 43 and thence to the appropriate layer processing pipeline.

As shown in FIG. 3, the input (layer processing) unit 22, 23 also has and supports a surface write out (write back) data path 103 for writing surfaces that are to be compressed by the ACT encode/decode unit 60 back to memory.

As shown in FIG. 3, this write out data path 103 includes an appropriate write out layer processing pipeline 48 operable and configured to process a surface to be written out to memory, followed by a latency hiding buffer 66 in the form of one or more FIFO stages, for buffering the surface to be written out to memory before it is compressed (as the surface to be written out from memory will typically be provided in a linear, raster order, but will be compressed using a block-based compression scheme (as discussed above), such that the received surface data to be written out will need to be buffered so that it can be reconfigured into appropriate blocks for compressing).

Correspondingly, the write out path comprises an appropriate tiling and/or swizzling unit (stage) 67 for organising the linear output surface data into an appropriate tiled (block based) configuration for compressing.

These stages are in an embodiment configured in the write out path before the DMA controller that performs the write control, with the DMA controller then being followed by the encoder (compression) unit 60 which is then followed by the TLB unit that operates to write the (now compressed) surface data to memory.

As discussed above, this operation is controlled by the write requestor 67 issuing appropriate “write requests” for this operation.

As discussed above, in the present embodiments, the display processor 12 (the display processor unit) also includes a different (separate) (ADU) encoding unit (circuit) 32 (FIG. 2) that is operable to compress (encode) surfaces stored in memory and store those compressed surfaces in the memory. In the present embodiments, this additional compression unit supports the same compression schemes that the input units (layer processing units) of the set or sets of processing units support.

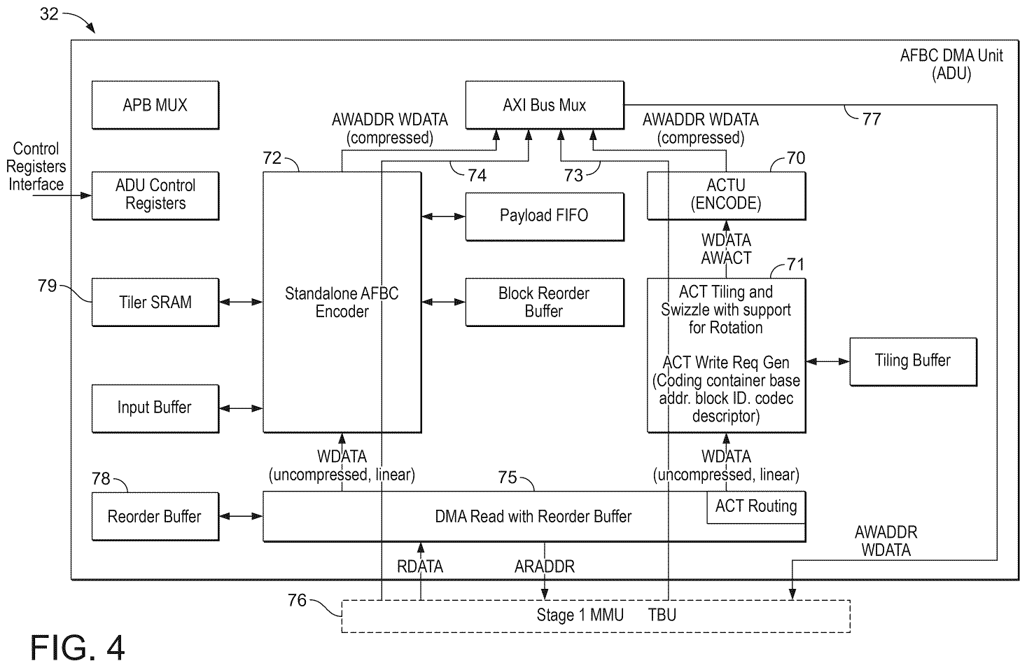

FIG. 4 shows this encoding unit 32 in more detail.

As shown in FIG. 4, this encoding unit 32 includes an appropriate memory access sub-system comprising a direct memory access (DMA) read controller 75 that is operable to read data of surfaces to be encoded (compressed) by the encoder unit 32 from memory (and that, accordingly, and as shown in FIG. 4, communicates with and has an interface to an appropriate memory management unit 76 (MMU)). The encoding unit 32 also includes an appropriate write path 77 for writing encoded (compressed) data of surfaces back to the memory (via the memory management unit 76).

As shown in FIG. 4, this additional encoding unit 32 supports (comprises) two data paths for the encoding (compression) of data of surfaces in memory, a first (write) data path 73, and a second (write) data path 74.

As shown in FIG. 4, the first data path 73 is operable to encode (and then write to memory) input surfaces using the same encoding scheme as is used for the second data path 101 in the set or sets of processing units.

Thus as shown in FIG. 4, this data path 73 includes an integrated encoder (encoding) unit (circuit) (ACTU) 70 for compressing the data in the required format before it is written out to memory, and an appropriate tiling and/or swizzling and/or rotation unit (stage) 71 (prior to the encoding stage/unit 70) for organising the surface data to be compressed into an appropriate tiled (block based) configuration for compressing.

The encoding unit 32 also comprises an appropriate write request generating unit (circuit) 71 that is operable to and configured to generate appropriate write requests for such encoding operations (as discussed herein).

The DMA read controller 75 correspondingly supports appropriate routing of data for the data path 73 for such encoding operations.

As shown in FIG. 4, the second, different data path 74 of the separate encoding unit 32 in the present embodiments, supports encoding (compression) using the encoding scheme that is used for the third data path 102 in the set or sets of processing units.

Thus, this data path comprises an appropriate (AFBC) encoder 72 for encoding the surfaces that are to be handled via this (encoding) data path.

In the present embodiment, as shown in FIG. 4, the second, different data path 74 supports ARM Frame Buffer Compression (AFBC) (as described, for example, in United States Patent Application Publication No. US 2013/0034309 A1, the entire contents of which is incorporated herein by reference).

The second, different data path 74, also comprises a reorder unit, which includes a reorder buffer 78, prior to the encoder unit (stage) 72. In the present embodiment, this reorder unit is performed as part of and integrated with the DMA read controller operation, but other arrangements would be possible, if desired.

There is also a corresponding tiling unit (buffer 79), again prior to the encoding stage 72. As shown in FIG. 4, in the present embodiments, the tiling unit/stage is integrated with, and performed as part of, the encoding process, but other arrangements would, of course, be possible.

The reorder and tiling stages operate to organise the surface data to be encoded (compressed) into an appropriate tiled (block-based) configuration for compressing (encoding) by the encoder 72.

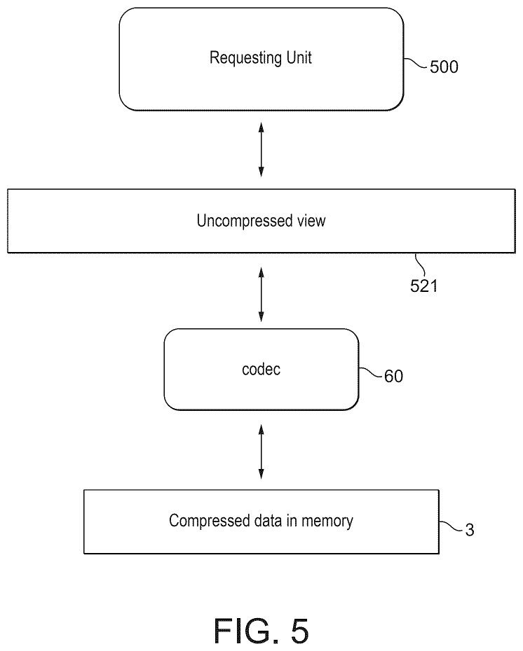

FIGS. 5 to 8 show schematically the operation of the ACT encode/decode unit 60 (and the ACT encode unit 70) in the present embodiments in more detail.

As shown in FIG. 5, the ACT encode/decode unit 60 is provided logically between the relevant requestor unit 500 (which may be the read requestor 64 or write requestor 67, for example) and the memory 3. The ACT encode/decode unit 60 is then operable to decompress data received from the memory system 3 before providing that data in an uncompressed form for use, and, conversely, to compress data that is to be written to the memory system 3 prior to writing that data to the memory 3 in compressed form.

As illustrated in FIG. 5, the ACT encode/decode unit 60 operates to effectively present an uncompressed view 21 of compressed data in the memory 3 to a requestor unit 500 that is acting as bus master (initiator/requester), such that the requestor unit 500 can access that uncompressed view of the compressed data through bus transactions.

As discussed in United States Patent Application Publication No. US 2024/0086340 A1 (Arm Limited), the entire contents of which is incorporated herein by reference, the use of bus transactions to communicate with and control encoding and decoding in this manner provides various advantages for compression and decompression in a data processing system. For example, the compression and decompression can be controlled using existing bus protocols, such as AXI. Thus, for example, a processing unit can control a codec using the same bus interface that it uses for other (e.g.) “direct” bus transactions. Moreover, the compressed data can be accessed in a “random access” manner.

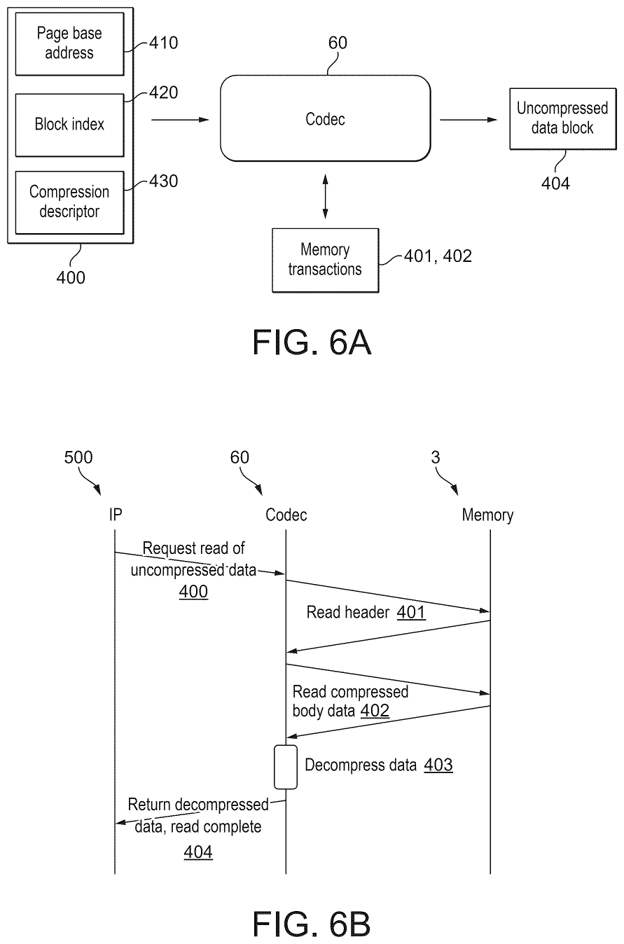

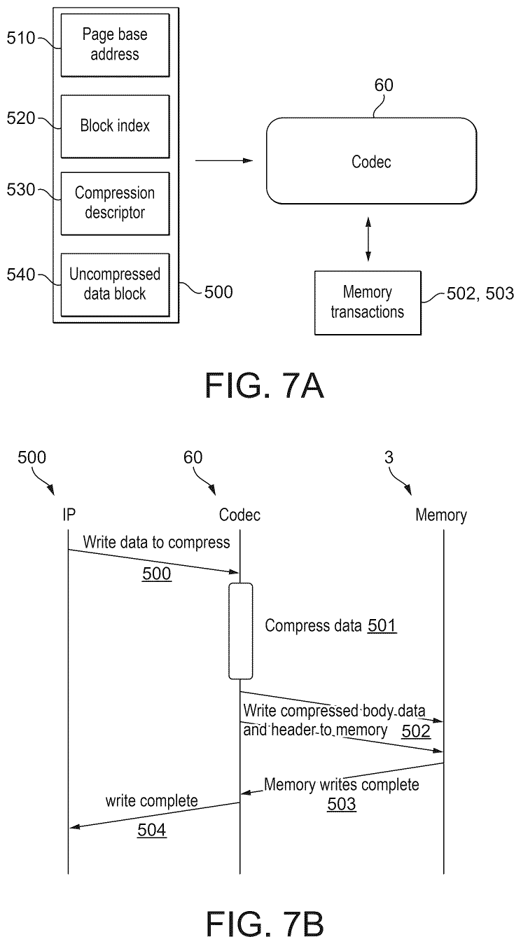

FIGS. 6A, 6B, 7A and 7B illustrate bus transactions in which a requestor unit 500 can access an uncompressed view of compressed image data that is stored in a compressed frame buffer in the memory 3 in accordance with embodiments.

FIG. 6A schematically illustrates a compressed data read transaction, and FIG. 6B is a corresponding sequence diagram, an embodiment.

As illustrated in FIGS. 6A and 6B, when data that is stored in the memory 3 in a compressed data block is required, a read transaction request 400 is issued on a read address channel of a bus via a bus interface. This includes issuing a “COMPRESSED” signal that indicates that the request relates to compressed data in the memory 3, and should trigger a bus transaction that involves the ACT encode/decode unit 60.

As shown in FIG. 6A, the read transaction request 400 further includes an indication 410, 420 of the memory address of the required compressed data block, and a compression descriptor 430. The memory address information includes an indication 410 of the location of header data for the compressed data block, and an indication 420 of the location of the block within the body data associated with the header.

The compression descriptor 430 is a signal vector that identifies the compression mechanism (codec) that the required data block is compressed in accordance with, and identifies the data format and data type in which the uncompressed data should be returned (e.g. RGB, RGBA, YUV, number of components, bits per component, whether data values are unsigned/signed integers, floating point numbers, etc.).

As shown in FIG. 6B, the ACT encode/decode unit 60 recognises and intercepts the request 400, reads 401 header information for the required compressed data block from the memory 3 using the header memory address information 410, and then reads 402 the appropriate compressed data block using the body memory address information 420. The codec then decompresses 403 the read compressed data block in accordance with the compression descriptor information 430, and provides the decompressed data and signals 404 that the read transaction is complete on a read data channel of the bus.

FIG. 7A schematically illustrates a compressed data write transaction, and FIG. 7B is a corresponding sequence diagram, an embodiment.

As illustrated in FIGS. 7A and 7B, when (uncompressed) data is to be stored in the memory 3 in a compressed data block, a write transaction request 500 is issued on the bus via a bus interface. This includes the processing unit issuing a “COMPRESSED” signal on a write address channel of the bus that indicates that the request relates to compressed data for the memory 3, and should trigger a bus transaction that involves the ACT encode/decode unit 60.

As shown in FIG. 7A, the write transaction request 500 further includes the (uncompressed) data 540 that is to be stored in compressed form in the memory 3, an indication 510, 520 of the memory address at which the compressed data block should be stored in the memory 3, and a compression descriptor 530. The memory address information includes an indication 510 of the memory location for header data for the compressed data block, and an indication 520 of the memory location for the block within body data associated with the header.

In this case, the compression descriptor 530 is a signal vector that identifies the compression mechanism (codec) that the data should be compressed in accordance with, and identifies the data format and data type in which the uncompressed data is provided (e.g. RGB, RGBA, YUV, number of components, bits per component, and whether data values are unsigned/signed integers, floating point numbers, etc.).

As shown in FIG. 7B, the ACT encode/decode unit 60 recognises and intercepts the request 500, compresses 501 the uncompressed data 540 in accordance with the compression descriptor information 530, and writes 502 the compressed data block to the memory 3 together with appropriate header information based on the memory address information 510, 520. When the memory write is complete 503, the ACT encode/decode unit 60 signals 504 that the write transaction is complete on a write response channel of the bus.

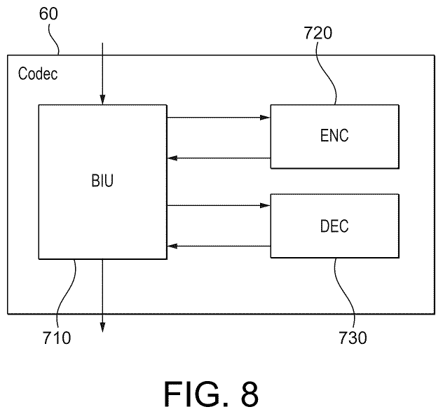

FIG. 8 shows the codec unit 60 in more detail an embodiment. As shown in FIG. 8, the codec unit 60 includes a bus interface module (BIU) 710, an encoder module 720, and a decoder module 730. The bus interface module 710 receives bus transactions via the bus and determines the manner in which the ACT encode/decode unit 60 should respond to received bus transactions.

In the case of a compressed data read transaction, the bus interface module 710 passes compressed data to be decompressed to the decoder module 730, and the decoder module 730 decompresses the data, and returns decompressed data to the bus interface module 710. The bus interface module 710 then forwards the decompressed data appropriately. The bus interface module 710 may initiate a bus transaction to read the compressed data to be decompressed from the memory 3.

In the case of a compressed data write transaction, the bus interface module 710 passes data to be compressed to the encoder module 720, and the encoder module 720 compresses the data, and returns compressed data to the bus interface module 710. The bus interface module 710 then forwards the compressed data to the memory 3. The bus interface module 710 may initiate a bus transaction to write the compressed data to the memory 3.

In the case of a bus transaction that is not indicated as being related to compressed data, the bus interface module 710 appropriately forwards the bus transaction without the encoder or decoder modules 720, 730 being activated.

It can be seen from the above, that the technology described herein, in its embodiments at least, can provide more efficient and effective display processor operation when processing surfaces for display that may be stored in compressed or uncompressed form in memory. This is achieved in the embodiments of the technology described herein at least, by the input layer processing units of the display processor supporting plural different input surface data paths, which data paths are, respectively, configured for handling compressed or uncompressed surfaces.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A display processing unit for a data processing system, the display processing unit comprising:
at least one set of processing units comprising: an input unit operable to read and process one or more input surfaces, a processing unit operable to process one or more input surfaces to generate an output surface, and an output unit operable to provide an output surface for display to a display;
wherein:
the input unit comprises:
a first data path for the reading and processing of an input surface that is to be read from memory in an uncompressed form for providing to the processing unit; and
a second, different data path for the reading and processing of an input surface that is to be read from memory in a compressed form for providing to the processing unit.

2. The display processing unit of claim 1, wherein the first data path for uncompressed data comprises, after a memory access sub-system of the input unit, a reorder unit, followed by a layer processing pipeline.

3. The display processing unit of claim 1, wherein the second, different data path for input surfaces that are stored in a compressed form in memory comprises a decoding unit that is operable to decode compressed data received from memory.

4. The display processing unit of claim 3, wherein the decoding unit is provided as part of a memory access sub-system of the input unit.

5. The display processing unit of claim 3, wherein the decoding unit is configured to receive bus transactions on a communications bus to perform memory accesses, and wherein when a memory access is a request to read in data that is to be decompressed by the decoding unit, the bus transaction causes the requested data to be read in via, and decompressed by, the decoding unit.

6. The display processing unit of claim 1, wherein the second, different, data path for compressed input surfaces comprises:
a de-swizzle and/or rotation unit configured to de-swizzle, and/or rotate, decompressed blocks of data for an input surface to reorder the data elements in those blocks of data into a different order.

7. The display processing unit of claim 1, wherein the second, different data path comprises a de-tiling unit configured to convert blocks of decompressed data for an input surface into a linear data order for processing.

8. The display processing unit of claim 1, wherein the input unit also comprises a write out data path via which a surface may be written out to memory in a compressed form.

9. The display processing unit of claim 1, wherein the input unit further comprises a third, different data path that is configured for the reading and processing of input surfaces that are compressed in a different compressed form to the compressed surfaces that are handled via the second data path.

10. The display processing unit of claim 9, wherein the input unit comprises a reorder unit that is shared by the first and third data paths.

11. The display processing unit of claim 9, wherein the input unit comprises a de-tiling unit configured to convert blocks of decompressed data for an input surface into a linear data order for processing that is shared by the second and third data paths.

12. The display processing unit of claim 1, further comprising a separate encoding unit that is operable to compress surfaces stored in memory and store those compressed surfaces in memory.

13. The display processing unit of claim 12, wherein the separate encoding unit comprises:
a first data path that is operable to encode and then write to memory input surfaces using a first set of one or more encoding schemes; and
a second, different data path that is operable to encode and then write to memory input surfaces using a second, different set of one or more encoding schemes.

14. A method of operating a display processing unit for a data processing system, the display processing unit comprising:
at least one set of processing units comprising: an input unit operable to read and process one or more input surfaces, a processing unit operable to process one or more input surfaces to generate an output surface, and an output unit operable to provide an output surface for display to a display;
wherein:
the input unit comprises:
a first data path for the reading and processing of an input surface that is to be read from memory in an uncompressed form for providing to the processing unit; and
a second, different data path for the reading and processing of an input surface that is to be read from memory in a compressed form for providing to the processing unit;
the method comprising:
when an input surface is to be read from memory in an uncompressed form for providing to the processing unit, reading and processing the input surface via the first data path of the input unit; and
when an input surface is to be read from memory in a compressed form for providing to the processing unit, reading and processing the input surface via the second data path of the input unit.

15. The method of claim 14, wherein processing an uncompressed input surface via the first data path comprises reordering the data elements in the input surface and providing the reordered data elements to a layer processing pipeline.

16. The method of claim 14, wherein processing a compressed input surface via the second data path comprises decoding the compressed input surface by a decoding unit of the input unit.

17. The method of claim 16, wherein the decoding unit is configured to receive bus transactions on a communications bus to perform memory accesses, and the method comprises:
sending a bus transaction comprising a request to read in data that is to be decompressed by the decoding unit; and
the bus transaction causing the requested data to be read in via, and decompressed by, the decoding unit.

18. The method of claim 14, wherein processing a compressed input surface via the second data path comprises:
de-swizzling and/or rotating decompressed blocks of data for the input surface to reorder the data elements in those blocks of data into a different order.

19. The method of claim 14, wherein processing a compressed input surface via the second data path comprises:
converting blocks of decompressed data for the input surface into a linear data order for processing.

20. The method of claim 14, wherein the input unit further comprises a third, different data path that is configured for the reading and processing of input surfaces that are compressed in a different compressed form to the compressed surfaces that are handled via the second data path; and
the method comprises:
when an input surface is to be read from memory in a compressed form that the third different data path is configured for providing to the processing unit, reading and processing the input surface via the third data path of the input unit.

21. The method of claim 20, comprising using a same reorder unit to reorder data elements in an input surface when processing an input surface via the first or third data path.

22. The method of claim 20, comprising using a same de-tiling unit to convert blocks of decompressed data for an input surface into a linear data order for processing when processing an input surface via the second or third data path.

23. A non-transitory computer readable storage medium storing computer software code which when executing on one or more processors performs a method of operating a display processing unit for a data processing system, the display processing unit comprising:
at least one set of processing units comprising: an input unit operable to read and process one or more input surfaces, a processing unit operable to process one or more input surfaces to generate an output surface, and an output unit operable to provide an output surface for display to a display;
wherein:
the input unit comprises:
a first data path for the reading and processing of an input surface that is to be read from memory in an uncompressed form for providing to the processing unit; and
a second, different data path for the reading and processing of an input surface that is to be read from memory in a compressed form for providing to the processing unit;
the method comprising:
when an input surface is to be read from memory in an uncompressed form for providing to the processing unit, reading and processing the input surface via the first data path of the input unit; and
when an input surface is to be read from memory in a compressed form for providing to the processing unit, reading and processing the input surface via the second data path of the input unit.
